(19) United States
(12) Patent Application Publication
(10) Pub. No.: US 2026/0021539 A1
(43) Pub. Date: Jan. 22, 2026

(54) METHOD FOR MANUFACTURING WELDED MEMBER

(71) Applicant: FUTABA INDUSTRIAL CO., LTD., Okazaki-shi (JP)

(72) Inventors: Shota Muto, Okazaki-shi (JP); Yusuke Oshima, Okazaki-shi (JP)

(21) Appl. No.: 19/245,488

(22) Filed: Jun. 23, 2025

(30) Foreign Application Priority Data
Jul. 16, 2024 (JP) 2024-113344

(51) Int. Cl. B23K 26/26

(52) U.S. Cl. CPC B23K 26/26

(57) ABSTRACT

In a method for manufacturing a welded member, an irradiation area that is irradiated by a laser beam relatively moves along end surfaces. The irradiation area includes a first area, a second area, and a third area. The second area surrounds an outer circumference of the first area. The third area is located outside of the second area and at least forward of the second area in a moving direction. The moving direction is a direction in which the irradiation area relatively moves. A rear end of the third area is located in front of a rear end of the second area in the moving direction. A first power density q1, a second power density q2, and a third power density q3 of the laser beam with which the first area, the second area, and the third areas are respectively irradiated satisfy a relationship q1>q2, q3.

### CROSS-REFERENCE TO RELATED APPLICATIONS

This application claims the priority based on Japanese Patent Application No. 2024-113344 filed on Jul. 16, 2024 with the Japan Patent Office, the entire disclosure of which is incorporated herein by reference.

### BACKGROUND

The present disclosure relates to a method for manufacturing a welded member.

For example, Unexamined Japanese Patent Application Publication No. 2023-7119 discloses a method for forming a welded member. In the method, two metal plates, with their end surfaces abutted against each other, are welded together by applying a laser beam along the end surfaces.

### SUMMARY

In this type of method for manufacturing a welded member, when end surfaces of two metal plates are abutted against each other, a gap may be created between the end surfaces. In this case, there may be a possibility that the gap is not sufficiently sealed despite irradiation with a laser beam, and a hole resulting from the gap may remain in a finished welded member.

One aspect of the present disclosure desirably provides a technique that facilitates, even if a gap is created between end surfaces of two metal plates abutted against each other, forming a welded member without a hole resulting from the gap.

One aspect of the present disclosure provides a method for manufacturing a welded member. The method includes forming the welded member by welding a first metal plate and a second metal plate together, the welding including applying a laser beam along an end surface of the first metal plate and an end surface of the second metal plate with the end surfaces abutted against each other. An irradiation area that is an area irradiated by the laser beam relatively moves along the end surfaces. The irradiation area includes a first area, a second area, and a third area. The second area surrounds an outer circumference of the first area. The third area is located outside of the second area and at least forward of the second area in a moving direction. The moving direction is a direction in which the irradiation area relatively moves. A rear end of the third area is located in front of a rear end of the second area in the moving direction. A first power density q1, a second power density q2, and a third power density q3 satisfy a relationship q1>q2, q3. The first power density q1 represents the power density of the laser beam with which the first area is irradiated. The second power density q2 represents the power density of the laser beam with which the second area is irradiated. The third power density q3 represents the power density of the laser beam with which the third area is irradiated.

Even if a gap is created between the end surfaces of the first metal plate and the second metal plate abutted against each other, this configuration can facilitate forming of the welded member without a hole resulting from the gap.

In one aspect of the present disclosure, the first power density q1, the second power density q2, and the third power density q3 may satisfy a relationship q1>q3>q2. Even if a gap is created between the end surfaces of the first metal plate and the second metal plate abutted against each other, this configuration can further facilitate forming of the welded member without a hole resulting from the gap.

In one aspect of the present disclosure, the second area may be in contact with the first area. This configuration can inhibit spatter from being generated during irradiation with the laser beam.

In one aspect of the present disclosure, the third area may be spaced from the second area by an interval.

In one aspect of the present disclosure, the irradiation area may have a dimension in the moving direction smaller than its dimension in a direction perpendicular to the moving direction. Even if a gap is created between the end surfaces of the first metal plate and the second metal plate abutted against each other, this configuration can further facilitate forming of the welded member without a hole resulting from the gap.

In one aspect of the present disclosure, the first metal plate may have a thickness greater than a thickness of the second metal plate.

### BRIEF DESCRIPTION OF THE DRAWINGS

Some example embodiments of the present disclosure will be described hereinafter with reference to the accompanying drawings, in which:

FIG. 1 is a schematic diagram illustrating a method for manufacturing a welded member;

FIG. 2 is a schematic diagram of a welding apparatus;

FIG. 3 is a schematic enlarged partial view of the welding apparatus;

FIG. 4 is a schematic diagram illustrating an irradiation area;

FIG. 5A is a schematic diagram for explaining an abutting step;

FIG. 5B is a schematic diagram for explaining a welding step;

FIG. 5C is a schematic diagram illustrating the welding step at a stage after a stage shown in FIG. 5B;

FIG. 5D is a schematic diagram illustrating the welding step at a stage after the stage shown in FIG. 5C;

FIG. 6 is a schematic diagram showing directions in which molten metal is drawn;

FIG. 7A is a schematic diagram illustrating an irradiation area according to a first variation;

FIG. 7B is a schematic diagram illustrating an irradiation area according to a second variation;

FIG. 7C is a schematic diagram illustrating an irradiation area according to a third variation;

FIG. 7D is a schematic diagram illustrating an irradiation area according to a fourth variation;

FIG. 7E is a schematic diagram illustrating an irradiation area according to a fifth variation;

FIG. 7F is a schematic diagram illustrating an irradiation area according to a sixth variation;

FIG. 7G is a schematic diagram illustrating an irradiation area according to a seventh variation; and

FIG. 7H is a schematic diagram illustrating an irradiation area according to an eighth variation.

### DETAILED DESCRIPTION OF EXEMPLARY EMBODIMENTS

### 1. Overview

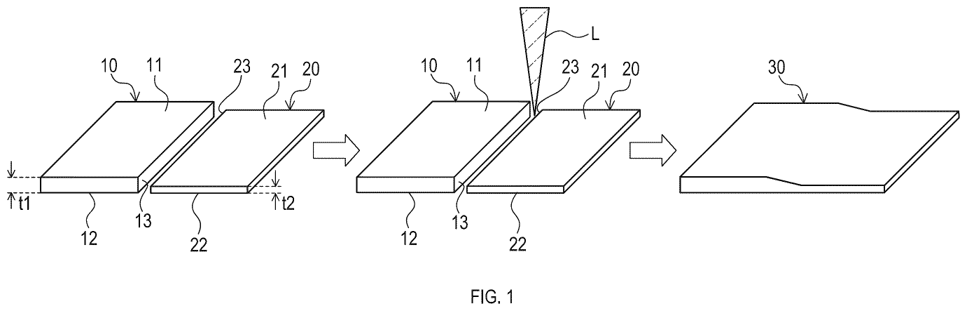

As shown in FIG. 1, a first metal plate 10 and a second metal plate 20 are welded together to form a welded member 30. Each of the first metal plate 10 and the second metal plate 20 is a plate-shaped metal member. Each of the first metal plate 10 and the second metal plate 20 is, for example, a steel plate. Specific examples of the steel plate include galvanized steel plates.

Each of the first metal plate 10 and the second metal plate 20 is, for example, in the form of a flat plate. Each of the first metal plate 10 and the second metal plate 20 has, for example, a rectangular shape in a front view. In the present disclosure, a front view of a plate-shaped member means a view in which the plate-shaped member is viewed from a direction along its plate thickness.

The first metal plate 10 has a thickness t1 that is, for example, greater than a thickness t2 of the second metal plate 20. The thickness t1 of the first metal plate 10 means the dimension of the first metal plate 10 in its plate thickness direction (that is, the dimension from a front surface 11 to a back surface 12 of the first metal plate 10). The thickness t2 of the second metal plate 20 means the dimension of the second metal plate 20 in its plate thickness direction (that is, the dimension from a front surface 21 to a back surface 22 of the second metal plate 20).

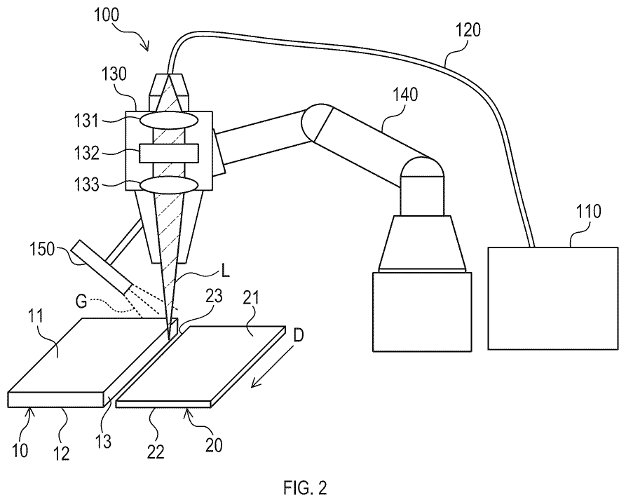

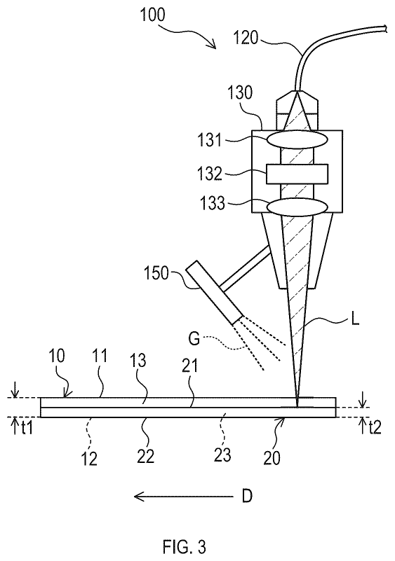

Hereinafter, a welding apparatus 100 shown in FIG. 2 and FIG. 3 will be described in detail. The welding apparatus 100 is used for welding the first metal plate 10 and the second metal plate 20 together. Also, a method for manufacturing the welded member 30, shown in FIG. 1, using the welding apparatus 100 will be described below. In cases where the welded member 30 is to undergo additional processing, such as press-forming, the welded member 30 is also referred to as a tailored blank. If the welded member 30 is scheduled to undergo additional processing, the welded member 30 may be manufactured, for example, using the first metal plate 10 and the second metal plate 20 whose shapes corresponding to the shape of a finished article.

### 2. Welding Apparatus

As shown in FIG. 2, the welding apparatus 100 includes a laser oscillator 110, an optical fiber cable 120, an optical head 130, a robotic arm 140, and a gas nozzle 150.

The laser oscillator 110 is configured to generate a laser beam L. The laser oscillator 110 includes a laser medium, an excitation source, and an optical resonator which are not shown. In the laser oscillator 110, the laser medium is excited by the excitation source. Light emitted from the excited laser medium is amplified by the optical resonator and thereby the laser beam L with aligned phases is generated.

The optical fiber cable 120 forms an optical path of the laser beam L that extends from the laser oscillator 110 to the optical head 130. The laser beam L generated by the laser oscillator 110 is guided to the optical head 130 through the optical fiber cable 120.

The optical head 130 is configured to emit the laser beam L to the first metal plate 10 and the second metal plate 20. The optical head 130 includes a collimating lens 131, a diffractive optical element 132, and a focusing lens 133. The collimating lens 131, the diffractive optical element 132, and the focusing lens 133 are arranged in this order in an optical path of the laser beam L in the optical head 130. In other words, the laser beam L guided by the optical fiber cable 120 passes through the collimating lens 131, the diffractive optical element 132, and the focusing lens 133, in this order. The collimating lens 131 is configured to collimate the laser beam L. The diffractive optical element 132 is configured to split the collimated beam L. The focusing lens 133 is configured to adjust the degree of convergence of the split beam L. For example, the focusing lens 133 is configured to adjust the degree of convergence of the laser beam L so that the laser beam L converges at a point in front of the first metal plate 10 and the second metal plate 20.

The robotic arm 140 includes links coupled by joints. At the distal end of the robotic arm 140, the optical head 130 is mounted. The robotic arm 140 is configured to be capable of moving the optical head 130 in six degrees of freedom.

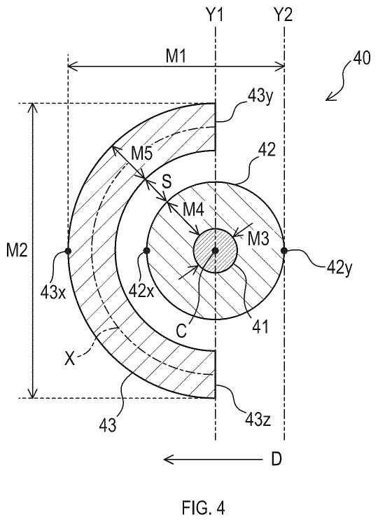

As the robotic arm 140 moves the optical head 130 while the optical head 130 emits the laser beam L, an irradiation area 40 shown in FIG. 4 relatively moves. The irradiation area 40 is an area that is irradiated by the laser beam L. More specifically, the irradiation area 40 is an area currently undergoing irradiation by the laser beam L. The irradiation area 40 has a length M1 smaller than its width M2. The length M1 is the dimension of the irradiation area 40 in a moving direction D. The width M2 is the dimension of the irradiation area 40 in a direction perpendicular to the moving direction D. The moving direction D is a direction in which the irradiation area 40 relatively moves. In a state where the first metal plate 10 and the second metal plate 20 are being irradiated with the laser beam L, the moving direction D is a direction of the relative movement of the irradiation area 40 with respect to the first metal plate 10 and the second metal plate 20. The irradiation area 40 has a first area 41, a second area 42, and a third area 43.

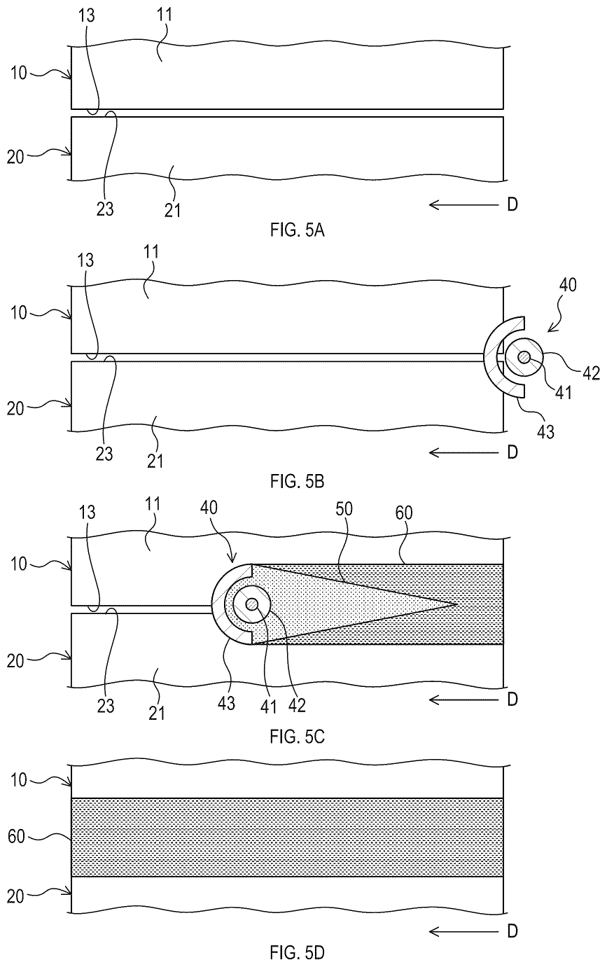

The first area 41 has a round shape. For example, the first area 41 is in the form of a perfect circle. The first area 41 has a diameter M3 that is, as shown in FIG. 5B, greater than the size of a gap which may be created between an end surface 13 of the first metal plate 10 and an end surface 23 of the second metal plate 20 (in other words, greater than the distance between the end surfaces 13 and 23). As shown in FIG. 1, the end surface 13 of the first metal plate 10 connects the front surface 11 and the back surface 12 of the first metal plate 10. The end surface 23 of the second metal plate 20 connects a front surface 21 and the back surface 22 of the second metal plate 20.

As shown in FIG. 4, the second area 42 surrounds the outer circumference of the first area 41. The second area 42 has an annular shape. For example, the second area 42 has an outer shape in the form of a perfect circle. The second area 42 is in contact with the first area 41. This state, in which the first area 41 and the second area 42 are in contact with each other, can be also said that the first area 41 and the second area 42 are continuously formed without an interval therebetween. Specifically, the second area 42 is in contact with the first area 41 along its entire circumference.

The second area 42 has a width M4 equal to the diameter M3 of the first area 41, for example. The width M4 of the second area 42 is the dimension of the second area 42 in the radial direction. In the present disclosure, the radial direction is a direction from a center C of the first area 41 to the outside of the first area 41 (that is, toward the second area 42). The width M4 of the second area 42 is the difference between the outer and the inner diameters of the second area 42.

The third area 43 is located outside of the second area 42 and at least forward of the second area 42 in the moving direction D. This state, in which the third area 43 is located at least forward of the second area 42 in the moving direction D, can be also said that at least a portion of the third area 43 is located in front of the second area 42 in the moving direction D. In the moving direction D, a front end 43x of the third area 43 is located in front of a front end 42x of the second area 42.

The third area 43 extends in the form of an arc along the outer circumference of the second area 42. For example, in a case where the outer shape of the second area 42 is in the form of a perfect circle, the third area 43 extends in the form of an arc along the outer circumference of the perfect circle. In this case, the central angle of a hypothetical arc X may be, for example, 180°. The hypothetical arc X continuously extends in the direction of extension of the third area 43 from one end of the third area 43 to the other end. The two ends of the third area 43 in the direction of its extension may be located at positions aligned with each other in the moving direction D, for example. In this case, the two ends in a direction of extension of the third area 43 respectively correspond to a rear end 43y and a rear end 43z in the moving direction D.

The third area 43 has a width M5 equal to the diameter M3 of the first area 41, for example. The width M5 of the third area 43 is equal to the width M4 of the second area 42, for example. The width M5 of the third area 43 is the dimension of the third area 43 in the radial direction.

The third area 43 is spaced from the second area 42 by an interval S. In other words, the third area 43 is not in contact with the second area 42. In other words, there is an area between the second area 42 and the third area 43 that is not irradiated with the laser beam L. The interval S between the second area 42 and the third area 43 is, for example, equal to the width M4 of the second area 42.

In FIG. 4, a first hypothetical line Y1 and a second hypothetical line Y2 are each shown as a double-dot dashed line. The first hypothetical line Y1 is a hypothetical straight line that is perpendicular to the moving direction D and passes through the center C of the first area 41. The second hypothetical line Y2 is a hypothetical straight line that is perpendicular to the moving direction D and passes a rear end 42y of the second area 42. In the moving direction D, the rear ends 43y and 43z of the third area 43 are located in front of the rear end 42y of the second area 42 (that is, in front of the second hypothetical line Y2). For example, in the moving direction D, the rear ends 43y and 43z of the third area 43 may be located at positions aligned with the center C of the first area 41 (that is, on the first hypothetical line Y1), or may be located in front of the center C of the first area 41 (that is, in front of the first hypothetical line Y1). In a case where the rear ends 43y and 43z of the third area 43 are located at positions aligned with the position of the center C of the first area 41 in the moving direction D, the first hypothetical line Y1 passes the rear ends 43y and 43z of the third area 43.

Each of the first area 41, the second area 42, and the third area 43 is irradiated with the laser beam L in a uniform manner. Each of the first area 41, the second area 42, and the third area 43 is irradiated with the laser beam L at a constant power density across each area. Power density is the output of the laser beam L per unit area for each of the first, the second, and the third areas. A first power density q1, a second power density q2, and a third power density q3 satisfy a relationship q1>q2, q3. The first power density q1, the second power density q2, and the third power density q3 satisfy a relationship q1>q3>q2, for example. The first power density q1 represents the power density of the laser beam L with which the first area 41 is irradiated. The second power density q2 represents the power density of the laser beam L with which the second area 42 is irradiated. The third power density q3 represents the power density of the laser beam L with which the third area 43 is irradiated.

Referring back to FIG. 2, the gas nozzle 150 is configured to eject a gas G. Examples of the gas G include air, argon, and nitrogen. The gas nozzle 150 is configured to be movable together with the optical head 130. In one example, the gas nozzle 150 is mounted to the optical head 130.

When the optical head 130 is moved, the gas nozzle 150 is positioned forward of the optical head 130 in the moving direction D. The gas nozzle 150 ejects the gas G from a position ahead of the laser beam L in the moving direction D to an area in front of the irradiation area 40. This inhibits metal vapor produced by irradiation of the first metal plate 10 and the second metal plate 20 with the laser beam L from remaining in the irradiation area 40.

### 3. Method for Manufacturing Welded Member

As shown in FIG. 1, the method for manufacturing the welded member 30 is a method for manufacturing the welded member 30 using the first metal plate 10 and the second metal plate 20. The method includes an abutting step and a welding step.

### [3-1. Abutting Step]

As shown in FIG. 5A, in the abutting step, the end surface 13 of the first metal plate 10 and the end surface 23 of the second metal plate 20 are abutted against each other. When the end surface 13 of the first metal plate 10 and the end surface 23 of the second metal plate 20 are placed in abutment, the end surfaces 13 and 23 may be, for example, in contact with each other without a gap therebetween, or there may be a gap created at least partially between the end surfaces 13 and 23 as shown in FIG. 5A. The first metal plate 10 and the second metal plate 20 are placed on a worktable (not shown) with their end surfaces 13 and 23 abutted against each other, for example.

In the drawing, an example is shown in which the first metal plate 10 and the second metal plate 20 are placed with their end surfaces 13 and 23 abutted against each other while their front surfaces 11 and 21 are face upward. However, the orientations of the first metal plate 10 and the second metal plate 20 are not limited to these orientations. The first metal plate 10 and the second metal plate 20 may be placed, for example, with their end surfaces 13 and 23 abutted against each other while their back surfaces 12 and 22 are face upward.

### [3-2. Welding Step]

Subsequent to the abutting step, the welding step is performed. As shown in FIG. 1, in the welding step, the first metal plate 10 and the second metal plate 20 are welded together by irradiation with the laser beam L, and the welded member 30 is formed. Specifically, the welding step is performed as follows.

As shown in FIG. 2, with the end surface 13 of the first metal plate 10 and the end surface 23 of the second metal plate 20 abutted against each other, the laser beam L is emitted from the optical head 130 of the welding apparatus 100 toward an area near the end surfaces 13 and 23. As shown in FIG. 5B and FIG. 5C, as the robotic arm 140 moves the optical head 130, the irradiation area 40 relatively moves along the end surface 13 of the first metal plate 10 and the end surface 23 of the second metal plate 20. The position of the optical head 130 is adjusted so that the first area 41 overlaps at least one of the end surface 13 of the first metal plate 10 or the end surface 23 of the second metal plate 20. For example, the position of the optical head 130 may be adjusted so that the first area 41 overlaps both the end surface 13 of the first metal plate 10 and the end surface 23 of the second metal plate 20. In a case where a gap is created between the end surface 13 of the first metal plate 10 and the end surface 23 of the second metal plate 20, the convergence of the laser beam L is adjusted so that the diameter M3 (see FIG. 4) of the first area 41 is larger than the gap.

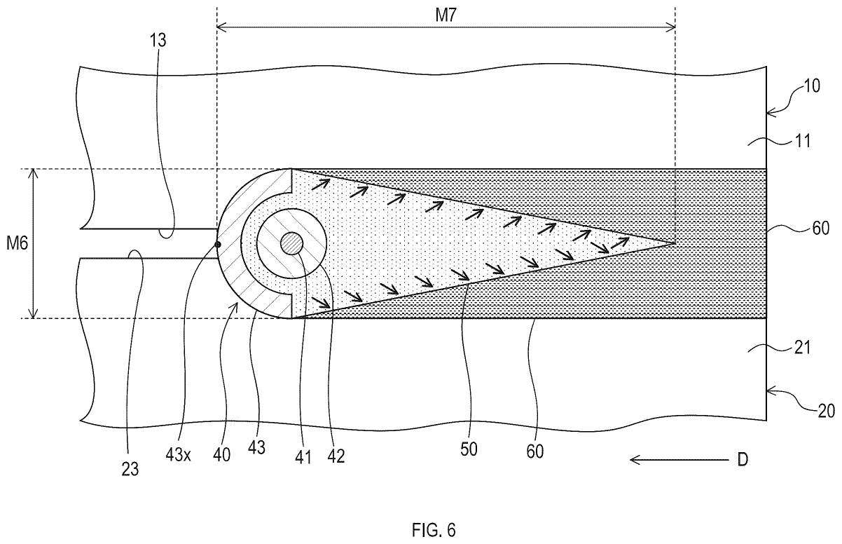

As shown in FIG. 5C, while the irradiation area 40 relatively moves, first, the laser beam L in the third area 43 melts metal in a portion of the first metal plate 10 that includes at least the end surface 13 and a portion of the second metal plate 20 that includes at least the end surface 23. Subsequently, metal is further melted by the laser beam L in the second area 42 and the first area 41. Molten metal forms a molten pool 50 that connects the first metal plate 10 and the second metal plate 20. The laser beam L in the first area 41 serves to deepen the depth of the molten pool 50. The depth of the molten pool 50 is the dimension of the molten pool 50 in the direction of irradiation with the laser beam L. The laser beam L in the second area 42 serves to facilitate melting of the metal caused by the laser beam L in the first area 41. The laser beam L in the third area 43 serves to widen a width M6 of the molten pool 50 shown in FIG. 6. The width M6 of the molten pool 50 is the dimension of the molten pool 50 in a direction perpendicular to the moving direction D.

As the irradiation area 40 relatively moves, in the portion that is currently overlapping the irradiation area 40, metal melts and forms a portion of the molten pool 50. In the portion that has ceased to overlap the irradiation area 40, the temperature gradually decreases and metal solidifies. That is, the molten pool 50 relatively moves in the moving direction D together with the irradiation area 40. Behind the molten pool 50 in the moving direction D, a joined portion 60 is formed in which metal has solidified. The joined portion 60 connects the first metal plate 10 and the second metal plate 20. The molten pool 50 has a length M7 equal to the maximum distance in the moving direction D from the front end 43x of the third area 43 to the joined portion 60. The length M7 of the molten pool 50 is the dimension of the molten pool 50 in the moving direction D.

The laser beam L is applied along the end surface 13 of the first metal plate 10 and the end surface 23 of the second metal plate 20. The irradiation area 40 relatively moves along the end surfaces 13 and 23 from one end of the end surfaces 13 and 23 to the other end. Accordingly, the first metal plate 10 and the second metal plate 20 are joined by the joined portion 60 as shown in FIG. 5D. As a result, the welded member 30 is achieved as shown in FIG. 1.

### 4. Effects

(4a) In a case, for example, where the first metal plate 10 and the second metal plate 20 are irradiated with a known laser beam, the molten pool 50 is formed and the following phenomena occur. Metal in the molten pool 50 solidifies from the rear side of the molten pool 50 in the moving direction D. In general, the volume of metal decreases as the metal solidifies. Thus, as shown in FIG. 6, molten metal (so-called liquid metal) in the molten pool 50 tends to be drawn toward a portion where metal solidifies. That is, the molten metal tends to be drawn to the rear side in the moving direction D. In addition, the molten metal tends to be drawn by surface tensions at the interface between the molten metal and the first metal plate 10 and the interface between the molten metal and the second metal plate 20. That is, the molten metal tends to be drawn toward the first metal plate 10 (in other words, toward the end surface 13) and toward the second metal plate 20 (in other words, toward the end surface 23). In FIG. 6, an example of the directions in which the molten metal is drawn are shown by bold arrows to facilitate understanding.

If too much molten metal is drawn to the rear side in the moving direction D, toward the first metal plate 10, or toward the second metal plate 20, there may be a shortage of molten metal immediately behind the irradiation area 40 in the moving direction D. Also, the connection between the first metal plate 10 and the second metal plate 20 through the molten pool 50 may no longer be maintained. In this case, as metal solidifies, a hole is formed in the finished form of the welded member 30 due to the gap between the end surface 13 of the first metal plate 10 and the end surface 23 of the second metal plate 20.

Thus, the laser beam L is used in the welding step in the manufacturing method of the present embodiment; the laser beam L creates the irradiation area 40 including the first area 41 to the third area 43. This configuration can accelerate the start of cooling of molten metal compared to a case where a laser beam of a comparative example is used. With the laser beam of the comparative example that creates an irradiation area including, for example, an area, in place of the third area 43, that surrounds the outer circumference of the second area 42 and that is uniformly irradiated with the laser beam.

By being able to accelerate the start of cooling of molten metal, it is possible to solidify the molten metal before too much molten metal is drawn to the rear side in the moving direction D, toward the first metal plate 10, or toward the second metal plate 20. That is, it is possible to solidify the molten metal while maintaining the connection between the first metal plate 10 and the second metal plate 20 through the molten pool 50. As a result, even if a gap is created between the end surface 13 of the first metal plate 10 and the end surface 23 of the second metal plate 20 in the abutting step, it is possible to facilitate forming of the welded member 30 without a hole resulting from the gap.

(4b) Furthermore, use of the laser beam L that creates the irradiation area 40 including the first area 41 to the third area 43 in the welding step enables formation of the molten pool 50 with enhanced stability. According to the present inventors, this is because the second area 42 is located around the outer circumference of the first area 41 in which the power density is the highest, and thus the power density gradually changes in the radial direction. In cases where the power density gradually changes in the radial direction, the temperature of the molten metal also gradually changes in the radial direction. As a result, it is possible to form the molten pool 50 with enhanced stability. The molten pool 50 with higher stability can better inhibit generation of spatter and can facilitate securing of a sufficient amount of molten metal. Thus, even if a gap is created between the end surface 13 of the first metal plate 10 and the end surface 23 of the second metal plate 20, it is possible to easily seal the gap.

(4c) In the present embodiment, the first power density q1 to the third power density q3 satisfy the relationship q1>q3>q2. The definitions of the first power density q1 to the third power density q3 are as described above. Such a configuration enables formation of the molten pool 50 with enhanced stability while reducing the total output of the laser beam L, compared to, for example, a configuration in which the first power density q1 to the third power density q3 satisfy a relationship q1>q2>q3. Reducing the total output of the laser beam L contributes to reducing the power consumption of the welding apparatus 100 and consequently to reducing the manufacturing cost of the welded member 30.

(4d) In a case where a gap is created between the end surface 13 of the first metal plate 10 and the end surface 23 of the second metal plate 20 in the abutting step, the laser beam L, when applied in the subsequent welding step, may leak from the gap.

However, with the configuration in which the first power density q1 to the third power density q3 satisfy the relationship q1>q3>q2, it is possible to reduce the portion of the total output of the laser beam L that leaks from the gap between the end surface 13 of the first metal plate 10 and the end surface 23 of the second metal plate 20, compared to a configuration in which a power density q1, a power density q2, and a power density q3 satisfy the relationship q1>q2>q3. In other words, it is possible to suppress the loss of the laser beam L from the gap. Thus, even if a gap is created between the end surface 13 of the first metal plate 10 and the end surface 23 of the second metal plate 20, it is possible to further facilitate melting of a portion of the first metal plate 10 that includes the end surface 13 and a portion of the second metal plate 20 that includes the end surface 23 by irradiation with the laser beam L. Thus, it is possible to maintain the connection more easily between the first metal plate 10 and the second metal plate 20 through the molten pool 50. As a result, it is possible to further facilitate forming of the welded member 30 without a hole resulting from the gap between the end surfaces 13 and 23.

(4e) The second area 42 is in contact with the first area 41. With this configuration, it is possible to more gradually change the power density in the radial direction. Thus, it is possible to more easily achieve the effects described in (4b).

(4f) The rear ends 43y and 43z of the third area 43 are located at positions aligned with the center C of the first area 41 in the moving direction D, or in front of the center C of the first area 41. That is, the third area 43 is located such that the third area 43 extends forward in the moving direction D from the center C of the first area 41. This configuration can further accelerate the start of cooling of molten metal. Thus, it is possible to more easily achieve the effects described in (4a).

(4g) The length M1 of the irradiation area 40 is smaller than the width M2 of the irradiation area 40. This configuration can further accelerate the start of cooling of molten metal. Thus, it is possible to more easily achieve the effects described in (4a).

### 5. Verification

The present inventors produced the welded member 30 using the first metal plate 10 and the second metal plate 20 in accordance with the above-described manufacturing method. The first metal plate 10 and the second metal plate 20 are each a zinc-plated steel plate. The thickness t1 of the first metal plate 10 was 1.6 mm. The thickness t2 of the second metal plate 20 was 1.4 mm. In the abutting step, the end surface 13 of the first metal plate 10 and the end surface 23 of the second metal plate 20 were abutted against each other so that a gap was intentionally created between the end surfaces 13 and 23. In the welding step, the first metal plate 10 and the second metal plate 20 were welded together using the welding apparatus 100. The first power density q1 to the third power density q3 were set so that the relationship q1>q3>q2 was satisfied. The definitions of the first power density q1 to the third power density q3 are as described above.

As a result, the welded member 30 was obtained without a hole resulting from the gap in both of the following cases: where the gap between the end surface 13 of the first metal plate 10 and the end surface 23 of the second metal plate 20 in the abutting step both was 0.1 mm, and where the gap was 0.2 mm. In the welding step, the ratio M7/M6 of the length M7 of the molten pool 50 to the width M6 of the molten pool 50 was approximately 3.6. Furthermore, in the welding step, generation of spatter during irradiation with the laser beam L was inhibited.

### 6. Other Embodiments

Although an embodiment of the present disclosure has been described hereinabove, the present disclosure should not be limited to the embodiment and may be implemented in various ways.

(6a) In the aforementioned embodiment, the central angle of the hypothetical arc X that continuously extends from one end of the third area 43 to the other end in the direction of extension of the third area 43 is, for example, 180°. The first hypothetical line Y1 passes, for example, the rear ends 43y and 43z of the third area 43. That is, the two ends in the direction of extension of the third area 43 are, for example, in contact with the first hypothetical line Y1.

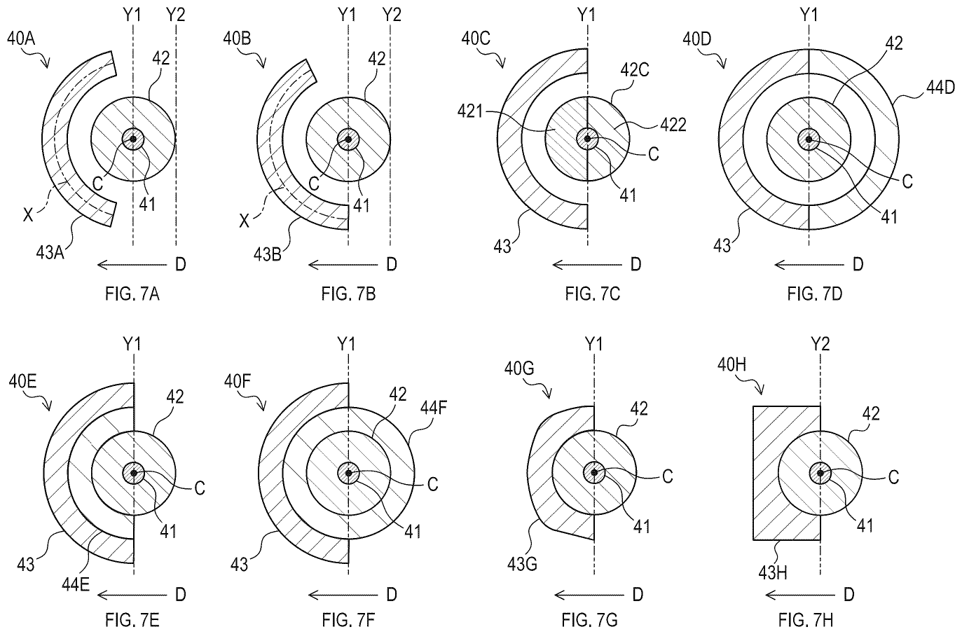

However, the central angle of the hypothetical arc X is not limited to a particular angle. For example, the central angle of the hypothetical arc X may be smaller than 180° as in, for example, an irradiation area 40A shown in FIG. 7A in which the hypothetical arc X continuously extends from one end of a third area 43A to the other end along the direction of extension of the third area 43A, and as in an irradiation area 40B shown in FIG. 7B in which the hypothetical arc X continuously extends from one end of a third area 43B to the other end along the direction of extension of the third area 43B. In this case, neither of the two ends in the direction of extension of the third area 43A has to be in contact with the first hypothetical line Y1 as shown in, for example, FIG. 7A, or any one of the two ends may be in contact with the first hypothetical line Y1 as shown in, for example, FIG. 7B.

(6b) In the aforementioned embodiment, the second area 42 is irradiated with the laser beam L in a uniform manner. The entirety of the second area 42 is irradiated with the laser beam L at a constant power density. However, a second area may include, for example, two or more areas that are irradiated by the laser beam L at distinct respective power densities.

For example, FIG. 7C shows an irradiation area 40C that includes a second area 42C in place of the above-described second area 42. The second area 42C includes a front area 421 and a rear area 422. The front area 421, together with the rear area 422, surrounds the outer circumference of the first area 41. The front area 421 extends forward in the moving direction D from the center C of the first area 41. The rear area 422 extends behind the center C of the first area 41 in the moving direction D. The first power density q1, a second front power density q21, a second rear power density q22, and the third power density q3 satisfy a relationship q1>q21, q22, q3 and a relationship q21>q22. For example, these power densities q1, q21, q22, and q3 may satisfy a relationship q1>q3>q21>q22. The definitions of the first power density q1 and the third power density q3 are as described above. The second front power density q21 represents the power density of the laser beam L with which the front area 421 is irradiated. The second rear power density q22 represents the power density of the laser beam L with which the rear area 422 is irradiated. Each of the second front power density q21 and the second rear power density q22 is included in the above-described second power density q2.

(6c) In the aforementioned embodiment, the irradiation area 40 only has the first area 41 to the third area 43. However, an irradiation area may further include a fourth area.

FIG. 7D shows an irradiation area 40D, as an example, that includes a fourth area 44D in addition to the first area 41 to the third area 43. The fourth area 44D extends in the form of an arc along the outer circumference of the second area 42. The fourth area 44D is located behind the center C of the first area 41 in the moving direction D. The fourth area 44D is spaced from the second area 42 by an interval. The fourth area 44D, together with the third area 43, surrounds the outer circumference of the second area 42.

FIG. 7E shows an irradiation area 40E, as another example, that includes a fourth area 44E in addition to the first area 41 to the third area 43. The fourth area 44E extends in the form of an arc along the outer circumference of the second area 42. The fourth area 44E is interposed between the second area 42 and the third area 43. The fourth area 44E is in contact with both the second area 42 and the third area 43.

FIG. 7F shows an irradiation area 40F, as a further example, that includes a fourth area 44F in addition to the first area 41 to the third area 43. The fourth area 44F surrounds the outer circumference of the second area 42 at a position radially inside of the third area 43. The fourth area 44F has an annular shape. The fourth area 44F is in contact with both the second area 42 and the third area 43.

In the examples shown in FIG. 7D to FIG. 7F, the first power density q1 to the fourth power density q4 satisfy a relationship q1>q2, q3>q4. For example, the power density q1, the second power density q2, the third power density, and the power density q4 may satisfy a relationship q1>q3>q2>q4. The definitions of the first power density q1 to the third power density q3 are as described above. The fourth power density q4 represents the power density of the laser beam L with which the fourth area 44D, 44E, or 44F is irradiated.

(6d) FIG. 7G shows an irradiation area 40G that includes a third area 43G. An area, such as the third area 43G, whose overall shape extends in the form of an arc while at least one of its inner or outer circumference in the radial direction meanders is included among examples of areas that extend in the form of an arc.

(6e) The shapes of the first to the third areas are not limited to the shapes illustrated in the aforementioned embodiments. In the embodiments, the first area 41 is in the form of, for example, a perfect circle. However, the first area may be in the form of, for example, an oval. In the embodiments, the second area 42 has an annular shape with a perfectly circular outer perimeter, for example. The second area may have an annular shape with an oval outer perimeter. In the embodiments, the third area 43 has a shape that extends in the form of an arc along the outer circumference of a perfect circle, for example. However, the third area may have a shape that extends in the form of an arc along the outer circumference of, for example, an oval. For example, as in an irradiation area 40H shown in FIG. 7H, a third area 43H may have a shape, other than an arc shape, that extends along the outer circumference of the second area 42.

(6f) In the aforementioned embodiments, the third area 43 is not in contact with the second area 42. As shown in FIG. 7G and FIG. 7H, the third area 43G and the third area 43H may be in contact with, for example, the second area 42. In other words, the third area 43G and the third area 43H may continuously extend from, for example, the second area 42.

(6g) In the aforementioned embodiments, moving the optical head 130 with the robotic arm 140 causes the irradiation area 40 to relatively move. However, the way to achieve the relative movement of the irradiation area 40 is not limited to a particular way. For example, a known machining device may be used in place of the robotic arm 140 to cause the relative movement of the irradiation area 40. In another example, a known galvanometer scanner may be used as the optical head 130, and a reflection mirror of the galvanometer scanner may cause the relative movement of the irradiation area 40. For cases where the first metal plate 10 and the second metal plate 20 are placed on a worktable, movement of the worktable with respect to the optical head 130 may cause the relative movement of the irradiation area 40.

(6h) Two or more functions achieved by one element of the above-described embodiments may be achieved by two or more elements. One function achieved by one element may be achieved by two or more elements. One function achieved by two or more elements may be achieved by one element. One function achieved by two or more elements may be achieved by one element. A part of the configurations in the above-described embodiments may be omitted. At least a part of the configurations in one of the above-described embodiments may be added to or replaced with the configuration in another one of the above-described embodiments.

What is claimed is:

1. A method for manufacturing a welded member, the method comprising:
forming the welded member by welding a first metal plate and a second metal plate together, the welding including applying a laser beam along an end surface of the first metal plate and an end surface of the second metal plate with the end surfaces abutted against each other,
an irradiation area that is an area irradiated by the laser beam, the irradiation area (i) relatively moving along the end surfaces, and (ii) including a first area, a second area, and a third area, the second area surrounding an outer circumference of the first area, the third area being located outside of the second area and at least forward of the second area in a moving direction, the moving direction being a direction in which the irradiation area relatively moves,
a rear end of the third area being located in front of a rear end of the second area in the moving direction, and
a first power density q1, a second power density q2, and a third power density q3 satisfying a relationship q1>q2, q3, the first power density q1 representing a power density of the laser beam with which the first area is irradiated, the second power density q2 representing a power density of the laser beam with which the second area is irradiated, the third power density q3 representing a power density of the laser beam with which the third area is irradiated.

2. The method according to claim 1, wherein the first power density q1, the second power density q2, and the third power density q3 satisfy a relationship q1>q3>q2.

3. The method according to claim 1, wherein the second area is in contact with the first area.

4. The method according to claim 1, wherein the third area is spaced from the second area by an interval.

5. The method according to claim 1, wherein the irradiation area has a dimension in the moving direction smaller than its dimension in a direction perpendicular to the moving direction.

6. The method according to claim 1, wherein the first metal plate has a thickness greater than a thickness of the second metal plate.
